(19) United States
(12) Patent Application Publication
(10) Pub. No.: US 2023/0217202 A1
(43) Pub. Date: Jul. 6, 2023

(54) AUDIO INTEGRATION OF PORTABLE ELECTRONIC DEVICES FOR ENCLOSED ENVIRONMENTS

(71) Applicant: Apple Inc., Cupertino, CA (US)

(72) Inventors: Daniel K. BOOTHE, San Francisco, CA (US); Onur I. ILKORUR, Santa Clara, CA (US); Marty E. JOHNSON, Los Gatos, CA (US); Chris WILK, Los Gatos, CA (US); Jonathan P. MOORE, Aptos, CA (US)

(21) Appl. No.: 17/966,756

(22) Filed: Oct. 14, 2022

Related U.S. Application Data
(60) Provisional application No. 63/296,829, filed on Jan. 5, 2022.

(51) Int. Cl. H04S 7/00; H04R 3/12; H04R 1/40; H04R 1/02; H04N 21/2187; H04N 21/81; H04S 3/00; H04R 5/02

(52) U.S. Cl. CPC H04S 7/302; H04R 3/12; H04R 1/403; H04R 1/025; H04N 21/2187; H04N 21/8106; H04S 3/008; H04R 5/02; H04R 2499/13; H04S 2400/01; H04S 2400/05; H04S 2400/11

(57) ABSTRACT

Implementations of the subject technology provide for audio integration of portable electronic devices into enclosed environments. A portable electronic device may be carried, by a user, into an enclosed environment, such as into an enclosure of a building, a room, or other apparatus. One or more remote speakers may be disposed in the enclosed environment. The remote speaker(s) may be operated in cooperation with the portable electronic device to spatially coordinate audio output from the remote speaker(s) with video content displayed by the portable electronic device.

### CROSS REFERENCE TO RELATED APPLICATIONS

This application claims the benefit of priority to U.S. Provisional Patent Application No. 63/296,829, entitled, “Audio Integration of Portable Electronic Devices for Enclosed Environments”, filed on Jan. 5, 2022, the disclosure of which is hereby incorporated herein in its entirety.

### TECHNICAL FIELD

The present description relates generally to acoustic devices, including, for example, audio integration of portable electronic devices for enclosed environments.

### BACKGROUND

Portable electronic devices that include speakers for outputting sound often also have the capability of pairing with a remote speaker via a Bluetooth connection. For example, when a Bluetooth-enabled speaker is within the proximity of a portable electronic device, the portable electronic device can transmit audio content to the Bluetooth-enabled speaker, for generation of audio output by the Bluetooth-enabled speaker. Typically, when a Bluetooth enabled speaker is available for audio output, the audio output of the Bluetooth-enabled speaker is used as an alternative to outputting the same audio output with the speaker of the portable electronic device.

### BRIEF DESCRIPTION OF THE DRAWINGS

Certain features of the subject technology are set forth in the appended claims. However, for purpose of explanation, several embodiments of the subject technology are set forth in the following figures.

FIGS. 1 and 2 illustrate aspects of an example apparatus in accordance with one or more implementations.

FIG. 3 illustrates a top view of an example apparatus having an enclosed space and various speakers in accordance with implementations of the subject technology.

FIG. 4 illustrates a perspective view of an example portable electronic device in accordance with one or more implementations.

FIG. 5 illustrates a top view of the example apparatus of FIG. 3 with the example portable electronic device of FIG. 4 at a location within the enclosed environment of the apparatus in accordance with implementations of the subject technology.

FIG. 6 illustrates a first example top view of an example apparatus and portable electronic device providing audio integration of the portable electronic device in accordance with implementations of the subject technology.

FIG. 7 illustrates a second example top view of an example apparatus and portable electronic device providing audio integration of the portable electronic device in accordance with implementations of the subject technology.

FIG. 8 illustrates a third example top view of an example apparatus and portable electronic device providing audio integration of the portable electronic device in accordance with implementations of the subject technology.

FIG. 9. illustrates a flow chart of example operations that may be performed by an apparatus for providing audio integration of a portable electronic device in accordance with implementations of the subject technology.

FIG. 10 illustrates a flow chart of example operations that may be performed for by a portable electronic device for providing audio integration of the portable electronic device in an enclosed environment in accordance with implementations of the subject technology.

FIG. 11 illustrates an example electronic system with which aspects of the subject technology may be implemented in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Portable electronic devices are often paired with a remote speaker via a wired or wireless connection (e.g., via a Bluetooth connection, a WiFi connection, or other wireless connection). In this way, the remote speaker can substitute for, or augment, audio output of audio content from the portable electronic device. This can be useful, for example, for generating sounds that are louder than can be generated by the relatively small speakers of portable electronic devices. For example, in one exemplary use case, a wireless-enabled speaker in a room, such as a conference room, can receive audio content from a portable electronic device, and generate audio output that better fills the room than would be possible using only the speaker(s) of the portable electronic device. In another exemplary use case, when a user carries their portable electronic device into a vehicle, the vehicle can receive audio content from the portable electronic device, and generate audio output that better fills the enclosed space within the vehicle than would be possible using only the speaker(s) of the portable electronic device.

In some exemplary use cases, a portable electronic device may also include a display, and may display video content with corresponding audio content. For example, the portable electronic device may be used to display a movie, an episode of a television show, gaming content, live-streaming content, or any other video content with associated audio content. When the portable electronic device is within the proximity of a remote speaker (e.g., in an enclosed space, such as in a room or in a vehicle), while the video content is being displayed by a display of the portable electronic device, the audio content corresponding to the video content may be transferred to the remote speaker. However, though this transfer of the audio content to the remote speaker can provide benefits such as additional volume, an expanded frequency range, and/or higher audio quality, the transfer can also cause an undesirable psychoacoustic perception for a user that the audio content is no longer spatially connected with the location at which the video content is being displayed.

Implementations of the subject technology described herein provide audio integration of portable electronic devices in enclosed environments. In one or more implementations, the audio integration can be provided in a way that creates the psychoacoustic perception that at least some of audio content that is being output in connection with video content being displayed on the portable electronic device (e.g., center content such as dialog content) is anchored to the location of the portable electronic device. As described in further detail hereinafter, in one or more implementations, this psychoacoustic perception can be achieved, in part, by modifying the timing with which the same audio content is output by a speaker of the portable electronic device and a remote speaker. As described in further detail hereinafter, in one or more implementations, this psychoacoustic perception can be achieved, in part, by operating a directional remote speaker to direct the audio content from the remote speaker to a desired location. As described in further detail hereinafter, in one or more implementations, this psychoacoustic perception can be achieved, in part, by operating a beamforming array of speakers to beam one or more portions of audio output from the array to one or more desired locations.

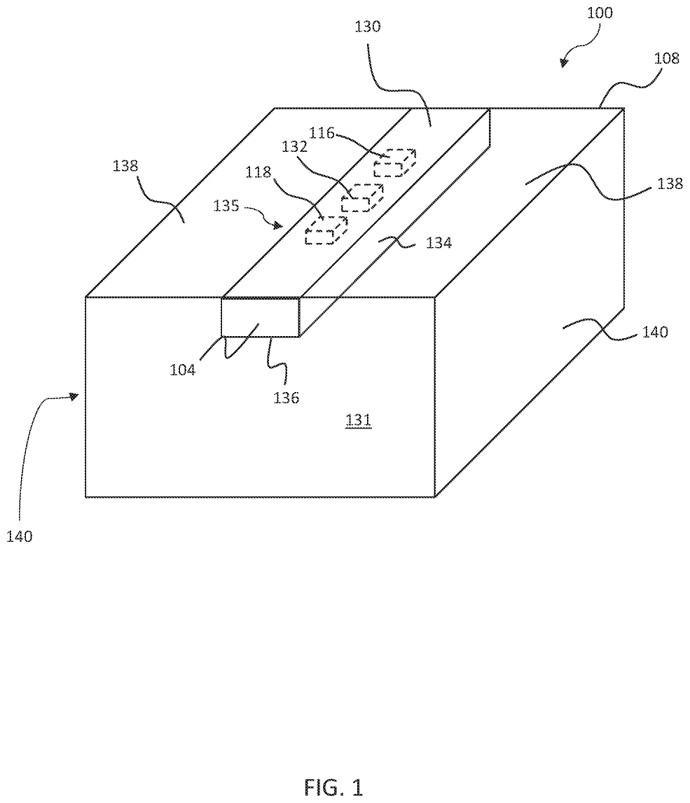

An illustrative apparatus including one or more speakers is shown in FIG. 1. In the example of FIG. 1, an apparatus 100 includes an enclosure 108 and a structural support member 104. The enclosure may (e.g., at least partially) define an enclosed environment 131. In the example of FIG. 1, the enclosure 108 includes top housing structures 138 mounted to and extending from opposing sides of the structural support member 104, and a sidewall housing structure 140 extending from each top housing structure 138.

In this example, the enclosure 108 is depicted as a rectangular enclosure in which the sidewall housing structures 140 are attached at an angle to a corresponding top housing structure 138. However, it is also appreciated that this arrangement is merely illustrative, and other arrangements are contemplated. For example, in one or more implementations, the top housing structure 138 and the sidewall housing structure 140 on one side of the structural support member 104 may be formed from a single (e.g., monolithic) structure having a bend or a curve between a top portion (e.g., corresponding to a top housing structure 138) and a side portion (e.g., corresponding to a sidewall housing structure 140). For example, in one or more implementations, the top housing structure 138 and the sidewall housing structure 140 on each side of the structural support member 104 may be formed from a curved glass structure. In this and/or other implementations, the sidewall housing structure 140 and/or other portions of the enclosure 108 may be or include a reflective surface (e.g., an acoustically reflective surface).

As illustrated in FIG. 1, the apparatus 100 may include various components such as one or more safety components 116, one or more speakers 118, and/or one or more other components 132. In the example of FIG. 1, the safety component 116, the speaker 118, and the other component 132 are mounted in a structural space 130 at least partially within the structural support member 104. The other component 132 may include, as examples, one or more cameras, and/or one or more sensors. The cameras and/or sensors may be used to identify a portable electronic device and/or an occupant within the enclosed environment 131 and/or to determine the location of a portable electronic device and/or an occupant within the enclosed environment 131. It is also contemplated that one or more safety components 116, one or more speakers 118, and/or one or more other components 132 may also, and/or alternatively, be mounted to the enclosure 108, and/or to and/or within one or more other structures of the apparatus 100. As shown in FIG. 1, the structural support member 104 may include a first side 134, an opposing second side 135, and a bottom surface 136 that faces an interior of the enclosed environment 131 defined by the enclosure 108.

In various implementations, the apparatus 100 may be implemented as a stationary apparatus (e.g., a conference room or other room within a building) or a moveable apparatus (e.g., a vehicle such as an autonomous or semiautonomous vehicle, a train car, an airplane, a boat, a ship, a helicopter, etc.) that can be temporarily occupied by one or more human occupants and/or one or more portable electronic devices. In one or more implementations, (although not shown in FIG. 1), the apparatus 100 may include one or more seats for one or more occupants. In one or more implementations, one or more of the seats may be mounted facing in the same direction as one or more other seats, and/or in a different (e.g., opposite) direction of one or more other seats.

In one or more implementations, the apparatus 100 may be implemented as a moveable platform such as a vehicle (e.g., an autonomous vehicle that navigates roadways using sensors and/or cameras and substantially without control by a human operator, a semiautonomous that includes human operator controls and that navigates roadways using sensors and/or cameras with the supervision of a human operator, or a vehicle with the capability of switching between a fully autonomous driving mode, a semiautonomous driving mode, and/or a human controlled mode). In various versions of such an implementation, one or more seats of the apparatus may be oriented toward the interior of the vehicle, facing out the sides of the vehicle (e.g., the left and/or right sides and/or the front and/or rear sides of the vehicle), facing toward the front of the vehicle, facing toward the rear of the vehicle, and/or rotatable between various orientations.

In one or more use cases, it may be desirable to provide audio content to one or more occupants within the enclosed environment 131. The audio content may include general audio content intended for all of the occupants and/or personalized audio content for one or a subset of the occupants. The audio content may be generated by the apparatus 100, or received by the apparatus from an external source or from a portable electronic device within the enclosed environment 131. For example, in implementations in which the apparatus 100 is a moveable apparatus, it may be desirable to anchor the perceived location of audio output to the location of a portable electronic device within the enclosed environment 131. In these and/or other use cases, it may be desirable to be able to direct the audio content, or a portion of the audio content, to one or more particular locations within the enclosed environment 131 and/or to suppress the audio content and/or a portion of the audio content at one or more other particular locations within the enclosed environment 131. In various examples, the speaker 118 may be implemented as a directional speaker (e.g., a directional speaker having sound-suppressing acoustic ducts, a dual-directional speaker, or an isobaric cross-firing speaker) or speaker of a beamforming speaker array.

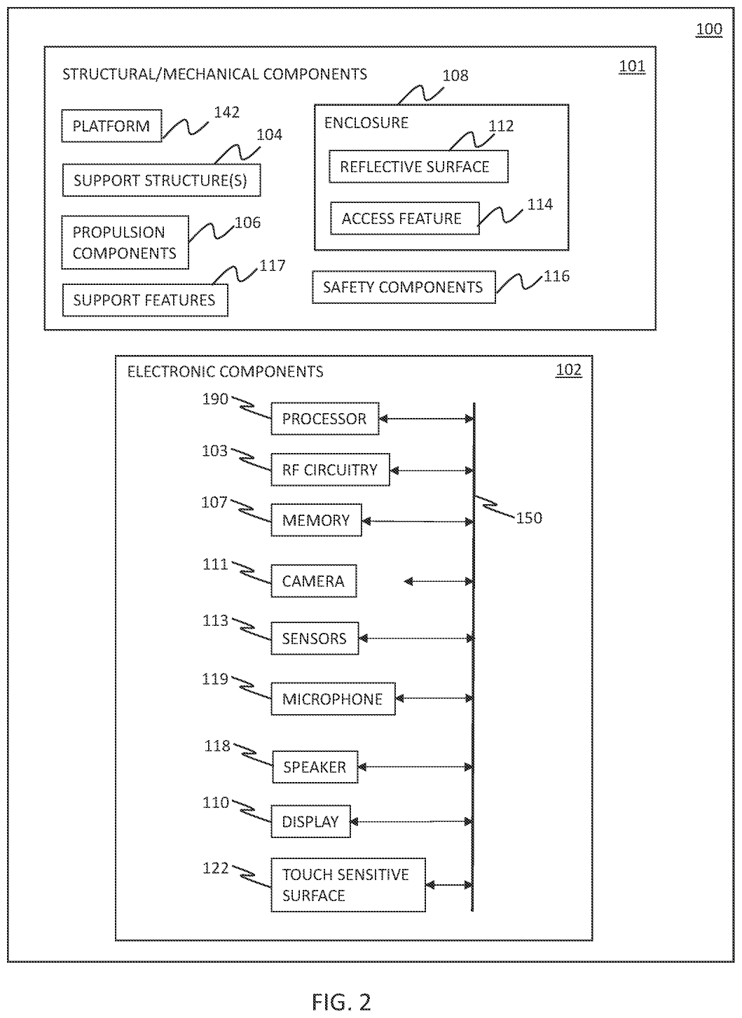

In various implementations, the apparatus 100 may include one or more other structural, mechanical, electronical, and/or computing components that are not shown in FIG. 1. For example, FIG. 2 illustrates a schematic diagram of the apparatus 100 in accordance with one or more implementations.

As shown in FIG. 2, the apparatus 100 may include structural and/or mechanical components 101 and electronic components 102. In this example, the structural and/or mechanical components 101 include the enclosure 108, the structural support member 104, and the safety component 116 of FIG. 1. In this example, the structural and/or mechanical components 101 also include a platform 142, propulsion components 106, and support features 117. In this example, the enclosure 108 includes a reflective surface 112 and an access feature 114.

As examples, the safety components 116 may include one or more seatbelts, one or more airbags, a roll cage, one or more fire-suppression components, one or more reinforcement structures, or the like. As examples, the platform 142 may include a floor, a portion of the ground, or a chassis of a vehicle. As examples, the propulsion components may include one or more drive system components such as an engine, a motor, and/or one or more coupled wheels, gearboxes, transmissions, or the like. The propulsion components may also include one or more power sources such as fuel tank and/or a battery. As examples, the support feature 117 may be support features for occupants within the enclosed environment 131 of FIG. 1, such as one or more seats, benches, and/or one or more other features for supporting and/or interfacing with one or more occupants. As examples, the reflective surface 112 may be a portion of a top housing structure 138 or a sidewall housing structure 140 of FIG. 1, such as a glass structure (e.g., a curved glass structure). As examples, the access feature 114 may be a door or other feature for selectively allowing occupants to enter and/or exit the enclosed environment 131 of FIG. 1.

As illustrated in FIG. 2, the electronic components 102 may include various components, such as a processor 190, RF circuitry 103 (e.g., WiFi, Bluetooth, near field communications (NFC) or other RF communications circuitry), memory 107, a camera 111 (e.g., an optical wavelength camera and/or an infrared camera, which may be implemented in the other components 132 of FIG. 1), sensors 113 (e.g., an inertial sensor, such as one or more accelerometers, one or more gyroscopes, and/or one or more magnetometers, radar sensors, ranging sensor such as LIDAR sensors, depth sensors, temperature sensors, humidity sensors, etc. which may also be implemented in the other components 132 of FIG. 1), a microphone 119, a speaker 118, a display 110, and a touch-sensitive surface 122. These components optionally communicate over a communication bus 150. Although a single processor 190, RF circuitry 103, memory 107, camera 111, sensor 113, microphone 119, speaker 118, display 110, and touch-sensitive surface 122 are shown in FIG. 2, it is appreciated that the electronic components 102 may include one, two, three, or generally any number of processors 190, RF circuitry 103, memories 107, cameras 111, sensors 113, microphones 119, speakers 118, displays 110, and/or touch-sensitive surfaces 122.

In the example of FIG. 2, apparatus 100 includes a processor 190 and memory 107. Processor 190 may include one or more general processors, one or more graphics processors, and/or one or more digital signal processors. In some examples, memory 107 may include one or more non-transitory computer-readable storage mediums (e.g., flash memory, random access memory, volatile memory, non-volatile memory, etc.) that store computer-readable instructions configured to be executed by processor 190 to perform the techniques described below.

In one or more implementations, cameras 111 and/or sensors 113 may be used to identify a portable electronic device and/or an occupant within the enclosed environment 131 and/or to determine the location of a portable electronic device and/or an occupant within the enclosed environment 131. For example, one or more cameras 111 may capture images of the enclosed environment 131, and the processor 190 may use the images to determine whether each seat within the enclosed environment 131 is occupied by an occupant. In various implementations, the processor 190 may use the images to make a binary determination of whether a seat is occupied or unoccupied, or may determine whether a seat is occupied by a particular occupant. In one or more implementations, the occupant can be actively identified by information provided by the occupant upon entry into the enclosed environment 131 (e.g., by scanning an identity card or a mobile device acting as an identity card with a sensor 113, or by facial recognition or other identity verification using the cameras 111 and/or the sensors 113), or passively (e.g., by determining that a seat is occupied and that that seat has been previously reserved for a particular occupant during a particular time period, such as by identifying an occupant of a seat as a ticketholder for that seat).

Communications circuitry, such as RF circuitry 103, optionally includes circuitry for communicating with electronic devices, networks, such as the Internet, intranet(s), and/or a wireless network, such as cellular networks, wireless local area networks (LANs), and/or direct peer-to-peer wireless connections. RF circuitry 103 optionally includes circuitry for communicating using near-field communication and/or short-range communication, such as Bluetooth®. RF circuitry 103 may include ultrawide band (UWB) circuitry for emitting and/or detecting a direction UWB signal (e.g., to and/or from a portable electronic device). RF circuitry 103 may be operated (e.g., by processor 190) to communicate with a portable electronic device in the enclosed environment 131. For example, the RF circuitry 103 may be operated to communicate with a portable electronic device to determine the presence of the portable electronic device in the enclosed environment 131, to identify the portable electronic device, to pair with the portable electronic device, to determine the location of the portable electronic device, and/or to receive information from the portable electronic device. As examples, the RF circuitry 103 may be operated to receive location information indicating a location of the portable electronic device within the enclosed environment 131, and/or to receive audio content from the portable electronic device for output by one or more speakers 118 based in part on the location of the portable electronic device within the enclosed environment 131.

In one or more implementations, one or more cameras 111 may capture images of the enclosed environment 131 and/or sensors 113 may obtain sensor information describing aspects of the enclosed environment (e.g., a depth map of the enclosed environment), and the processor 190 may use the images and/or sensor information to determine the location, within the enclosed environment 131, at which a paired portable electronic device is disposed. In one or more implementations, the portable electronic device may also, or alternatively, determine its own location within the enclosed environment, and provide location information indication the location to the processor 190 (e.g., via RF circuitry 103).

Display 110 may incorporate LEDs, OLEDs, a digital light projector, a laser scanning light source, liquid crystal on silicon, or any combination of these technologies. Examples of display 110 include head up displays, automotive windshields with the ability to display graphics, windows with the ability to display graphics, lenses with the ability to display graphics, tablets, smartphones, and desktop or laptop computers. In one or more implementations, display 110 may be operable in combination with the speaker 118 and/or with a separate display (e.g., a display of portable electronic device such as a smartphone, a tablet device, a laptop computer, a smart watch, or other device) within the enclosed environment 131.

Touch-sensitive surface 122 may be configured for receiving user inputs, such as tap inputs and swipe inputs. In some examples, display 110 and touch-sensitive surface 122 form a touch-sensitive display.

Camera 111 optionally includes one or more visible light image sensors, such as charged coupled device (CCD) sensors, and/or complementary metal-oxide-semiconductor (CMOS) sensors operable to obtain images within the enclosed environment 131 and/or of an environment external to the enclosure 108. Camera 111 may also optionally include one or more infrared (IR) sensor(s), such as a passive IR sensor or an active IR sensor, for detecting infrared light from within the enclosed environment 131 and/or of an environment external to the enclosure 108. For example, an active IR sensor includes an IR emitter, for emitting infrared light. Camera 111 also optionally includes one or more event camera(s) configured to capture movement of objects such as portable electronic devices and/or occupants within the enclosed environment 131 and/or objects such as vehicles, roadside objects and/or pedestrians outside the enclosure 108. Camera 111 also optionally includes one or more depth sensor(s) configured to detect the distance of physical elements from the enclosure 108 and/or from other objects within the enclosed environment 131. In some examples, camera 111 includes CCD sensors, event cameras, and depth sensors that are operable in combination to detect the physical setting around apparatus 100.

In some examples, sensors 113 may include radar sensor(s) configured to emit radar signals, and to receive and detect reflections of the emitted radar signals from one or more objects in the environment around the enclosure 108. Sensors 113 may also, or alternatively, include one or more scanners (e.g., a ticket scanner, a fingerprint scanner or a facial scanner), one or more depth sensors, one or more motion sensors, one or more temperature or heat sensors, or the like. In some examples, one or more microphones such as microphone 119 may be provided to detect sound from an occupant within the enclosed environment 131 and/or from one or more audio sources external to the enclosure 108. In some examples, microphone 119 includes an array of microphones that optionally operate in tandem, such as to identify ambient noise or to locate the source of sound in space.

Sensors 113 may also include positioning sensors for detecting a location of the apparatus 100, and/or inertial sensors for detecting an orientation and/or movement of apparatus 100. For example, processor 190 of the apparatus 100 may use inertial sensors and/or positioning sensors (e.g., satellite-based positioning components) to track changes in the position and/or orientation of apparatus 100, such as with respect to physical elements in the physical environment around the apparatus 100. Inertial sensor(s) of sensors 113 may include one or more gyroscopes, one or more magnetometers, and/or one or more accelerometers.

As discussed herein, speaker 118 may be implemented as a directional speaker (e.g., a directional speaker having sound-suppression acoustic ducts, a dual-directional speaker, or an isobaric cross-firing speaker), a speaker of a beamforming speaker array, or any other speaker having the capability (e.g., alone or in cooperation with one or more other speakers) to direct and/or beam sound to one or more desired locations.

For example, in one or more implementations, the speaker 118 may be implemented with an acoustic port through which sound (e.g., generated by a moving diaphragm or other sound-generating component) is projected, a back volume, and one or more sound-suppression acoustic ducts fluidly coupled to the back volume and configured to output sound from the back volume. Because the sound from the back volume will have a polarity (e.g., a negative polarity) that is opposite to a polarity (e.g., a positive polarity) output from the acoustic port, the sound from the back volume may cancel a portion of the sound from the acoustic port, in one or more directions defined by the arrangement of the one or more sound-suppression acoustic ducts. Each sound-suppressing acoustic duct may include one or more slots that aid in the directivity of the sound projected from that sound-suppressing acoustic duct.

As another example, speaker 118 may be implemented as a dual-directional speaker that includes a sound-generating element mounted between a pair of acoustic ducts. Sound generated by the sound-generating element may project sound into an aperture at the center of a channel housing that can then propagate down each of the acoustic ducts. Each acoustic duct may include one or more slots that aid in the directivity of the sound projected from that acoustic duct.

As another example, speaker 118 may be implemented as an isobaric cross-firing speaker that includes a housing defining a back volume, a first speaker diaphragm having a first surface adjacent the back volume and an opposing second surface facing outward, and a second speaker diaphragm having a first surface adjacent the back volume (e.g., the same back volume, which may be referred to herein as a shared back volume) and an opposing second surface facing outward at an angle different from the angle at which the first speaker diaphragm faces. In this configuration, in operation, the first speaker diaphragm projects sound in a first direction and the second speaker diaphragm projects sound in a second direction different from the first direction. The first speaker diaphragm and the second speaker diaphragm can be operated out of phase so that the sound generated by the second speaker diaphragm cancels at least a portion of the sound generated by the first speaker diaphragm at a location toward which the second speaker diaphragm faces.

As another example, the speaker 118 may be a speaker of a beamforming speaker array. In a beamforming speaker array, multiple speakers of the array can be co-operated to beam one or more desired sounds toward one or more desired locations within the enclosed environment 131.

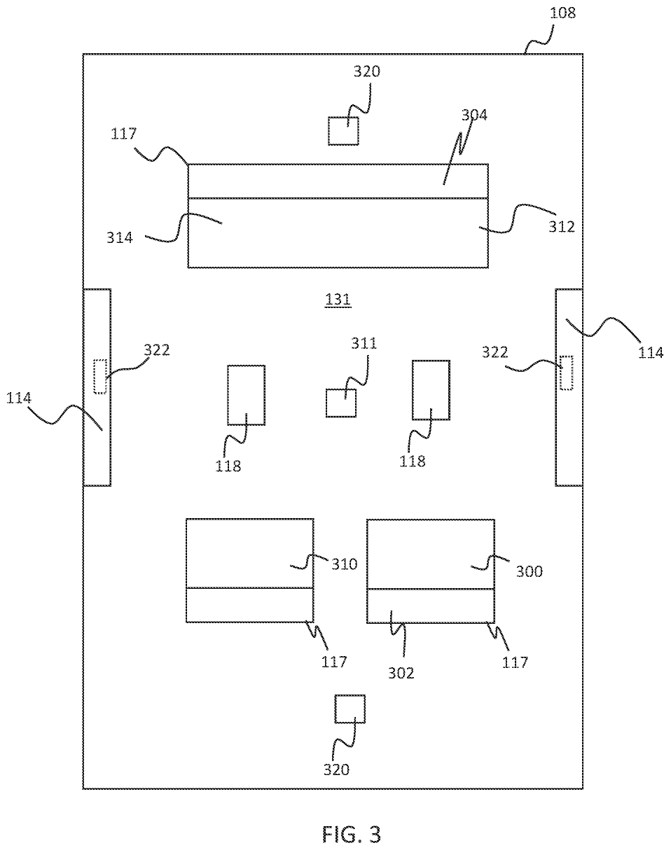

FIG. 3 illustrates a schematic top view of an example implementation of the apparatus 100 in which various speakers 118 (e.g., in one or more of the implementations described herein) are disposed at various locations within the apparatus 100. In the example of FIG. 3, the apparatus 100 includes the enclosure 108 and a seat 300 within the enclosure 108. As shown, the seat 300 may have a seat back 302 with a first side configured to interface with an occupant within the enclosure (e.g., when the occupant is seated on the seat 300 and resting their back against the seat back 302), and an opposing second side. As indicated, the seat 300 may be an implementation of the support feature 117 of FIG. 2.

In the example of FIG. 3, the apparatus 100 also includes a seat 310 facing in the same direction as the seat 300. In this example, the apparatus 100 also includes a seat 312 and a seat 314 having a seat back 304 and facing toward the seat 300 and the seat 310 (e.g., facing in an opposite direction to the direction in which the seat 300 and the seat 310 face). The orientation of the seats 312 and 314 of FIG. 3 is merely illustrative, and, in one or more other implementations, the seats 312 and/or 314 may face in the same direction as the seats 300 and 310 face (e.g., toward a front of the apparatus) or in another direction. In one or more implementations, the seat 312 and/or the seat 314 may be rotatable between multiple orientations. For example, in one or more implementations, the seat 314 may face in the direction of seat 310 as in FIG. 3 when the apparatus 100 is a vehicle operating in a fully autonomous driving mode, and may rotate to face away from the seat 310 (e.g., toward the front of the vehicle) when the vehicle is in a human-operator mode or in an semiautonomous mode. In one or more other implementations, the seat 312 and/or the seat 314 may be fixedly mounted in the forward facing direction.

In the example of FIG. 3, the apparatus 100 includes speakers 118 at various locations. It is appreciated that one, any sub-combination, or all of the speakers 118 shown in FIG. 3 may be implemented in the apparatus 100. It is also appreciated that additional speakers 118 may be implemented in the apparatus 100 at one or more other locations, and the locations of the speakers 118 of FIG. 3 are merely illustrative.

In the example, of FIG. 3, the apparatus 100 includes a speaker 118 disposed between the seat 300 and the seat 312, and a speaker 118 disposed between the seat 310 and the seat 314. In this example, the speaker 118 disposed between the seat 300 and the seat 312, and the speaker 118 disposed between the seat 310 and the seat 314 may be implemented as directional speakers (e.g., a directional speaker having one or more sound-suppressing acoustic ducts, a dual-directional speaker having a pair of acoustic ducts, or an isobaric cross-firing speaker, or any other directional speaker), configured to direct audio output toward one or more particular locations within the enclosed environment 131.

In the example of FIG. 3, the apparatus 100 includes a beamforming speaker array 320 (e.g., including multiple speakers 118 arranged in one or more concentric rings) substantially behind the seat 300 and the seat 310, and a beamforming speaker array 320 substantially behind the seat 312 and the seat 314. Each of the beamforming speaker arrays 320 can be operated to beam one or more audio outputs (e.g., multiple audio outputs corresponding to multiple respective audio channels) to one or more desired locations within the enclosed environment 131. In the example of FIG. 3, the apparatus 100 includes a beamforming speaker array 322 (e.g., including multiple speakers 118 arranged in one or more rows) mounted in an access feature 114 (e.g., a first door on a first side of the enclosure 108), and a beamforming speaker array 322 mounted in another access feature 114 (e.g., a second door on an opposing second side of the enclosure 108). Each of the beamforming speaker arrays 322 can be operated to beam one or more audio outputs (e.g., multiple audio outputs corresponding to multiple respective audio channels) to one or more desired locations within the enclosed environment 131. In one or more implementations, the speaker(s) 118, the beamforming speaker array(s) 320, and/or the beamforming speaker array(s) 322 may be operated (e.g., by the processor 190) to generate audio output based on a location of a portable electronic device that is disposed within and/or operating within the enclosed environment 131 of the apparatus 100.

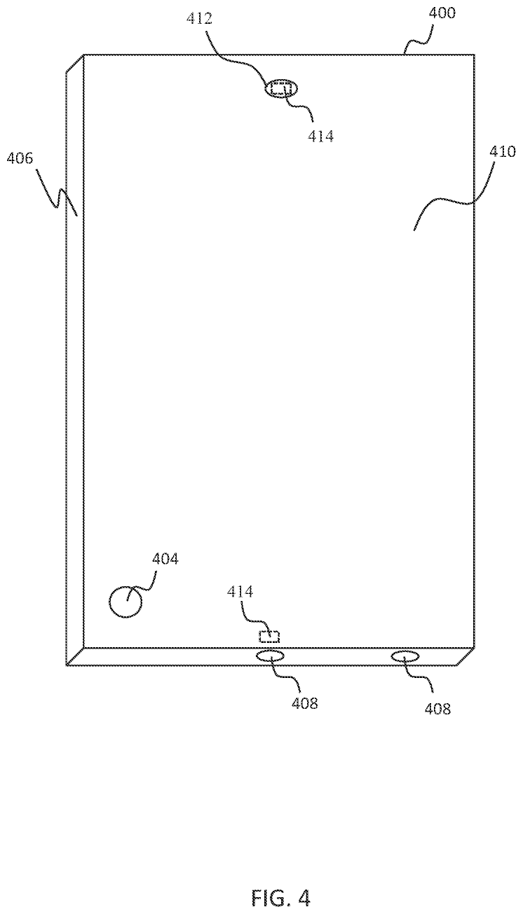

FIG. 4 illustrates a perspective view of an example portable electronic device that may be located and/or operated within the enclosed environment 131 of the apparatus 100. In the example of FIG. 4, a portable electronic device 400 has been implemented using a housing that is sufficiently small to be portable and carried by a user. For example, portable electronic device 400 of FIG. 4 may be a handheld electronic device such as a tablet computer or a cellular telephone or smart phone). As shown in FIG. 4, portable electronic device 400 includes a display such as display 410 mounted on the front of housing 406. Portable electronic device 400 includes one or more input/output devices such as a touch screen incorporated into display 410, a button or switch such as button 404 and/or other input output components disposed on or behind display 410 or on or behind other portions of housing 406. Display 410 and/or housing 406 include one or more openings to accommodate button 404, a device speaker, a microphone a light source, or a camera.

In the example of FIG. 4, housing 406 includes two openings 408 on a bottom sidewall of housing. One or more of openings 408 forms a port for an audio component. For example, one of openings 408 may form a speaker port for a device speaker 414 disposed within housing 406 and another one of openings 408 may form a microphone port for a device microphone disposed within housing 406. Although two openings 408 are shown in FIG. 4, this is merely illustrative. One opening 408, two openings 408, or more than two openings 408 may be provided on the bottom sidewall (as shown) on another sidewall (e.g., a top, left, or right sidewall), on a rear surface of housing 406 and/or a front surface of housing 406 or display 410 to accommodate one device speaker, two device speakers, or more than two device speakers. For example, portable electronic device 400 of FIG. 4 also includes an opening 412 in the display 410 for a device speaker 414. In some implementations, one or more groups of openings 408 in housing 406 may be aligned with a single port of an audio component within housing 406. Housing 406, which may sometimes be referred to as a case, may be formed of plastic, glass, ceramics, fiber composites, metal (e.g., stainless steel, aluminum, etc.), other suitable materials, or a combination of any two or more of these materials.

The configuration of portable electronic device 400 of FIG. 4 is merely illustrative. In other implementations, portable electronic device 400 may be a laptop computer, a wearable device such as a smart watch, a pendant device, or other wearable or miniature device, a media player, a gaming device, a navigation device, or any other portable electronic device having a speaker and display.

In some implementations, portable electronic device 400 may be provided in the form of a wearable device such as a smart watch. In one or more implementations, housing 406 may include one or more interfaces for mechanically coupling housing 406 to a strap or other structure for securing housing 406 to a wearer.

In one or more use cases, the portable electronic device 400 may operate the display 410 to display video content having associated audio content. In one or more use cases, the portable electronic device 400 may operate one or more device speakers 414 to generate audio output corresponding to some or all of the audio content. In one or more use cases, the portable electronic device 400 may provide some or all of the audio content to the apparatus 100 for generation of audio output by one or more of the speakers 118 of the apparatus 100. The apparatus 100 may then generate the audio output corresponding to the audio content received from the portable electronic device 400 based on a location of the portable electronic device 400 within the enclosed environment 131.

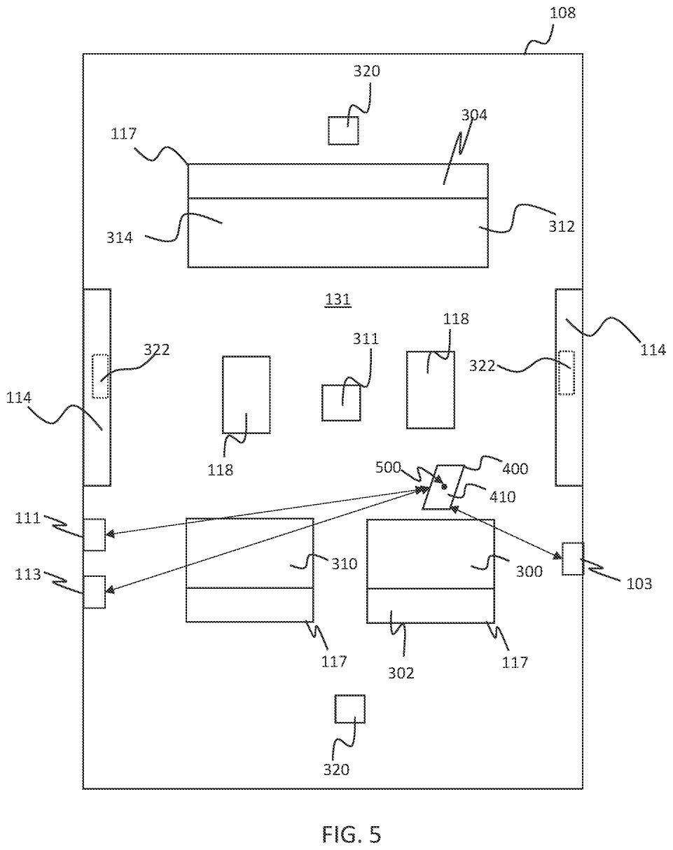

For example, FIG. 5 illustrates a use case in which the portable electronic device 400 of FIG. 4 is disposed within the enclosed environment 131 of the apparatus 100. As indicated in FIG. 5, one or more cameras 111, one or more sensor 113, and/or RF circuitry 103 of the apparatus 100 may be used to determine a location 500 of the portable electronic device 400 within the enclosed environment 131.

In one or more implementations, one or more camera(s) 111 may capture images of the enclosed environment 131, and the apparatus 100 (e.g., processor 190) may determine the location of the portable electronic device 400 within the enclosed environment 131 by detecting the portable electronic device 400 in the captured images, and determining the location of the portable electronic device 400 based on the location of the portable electronic device 400 in the captured images (e.g., and based on the known relative positions of multiple cameras at multiple positions around the enclosure 108 and/or based on known locations of other objects detected in the captured images). In one or more implementations, one or more sensors 113 may also, or alternatively, be used to determine the location of the portable electronic device 400 within the enclosed environment 131. For example, one or more depth sensors or ranging sensors at one or more positions around the enclosure 108 may be used to determine the distance from the known locations of the sensors, and the location of the portable electronic device 400 may be determined based on the determined distance(s). In one or more implementations, RF circuitry 103 may also, or alternatively, be used to determine the location of the portable electronic device 400 within the enclosed environment 131. For example, in one or more implementations, the portable electronic device 400 may determine its own location within the enclosure environment (e.g., using global positioning and/or inertial measurements, and/or using wireless (e.g., WiFi, NFC, or Bluetooth) communications with the RF circuitry 103, and transmit the determined location to the RF circuitry 103. In one or more other implementations, the RF circuitry 103 can ping the portable electronic device 400 and determine the location of the portable electronic device 400 within the enclosed environment 131 based on time-of-flight measurements corresponding to the ping. In various examples described herein, sensors 113, camera(s) 111, and/or RF circuitry 103 may be referred to as sensors or location sensors, when used to determine the location of the portable electronic device 400.

Once the location 500 of the portable electronic device 400 within the enclosed environment 131 has been determined, the apparatus 100 (e.g., processor 190) may operate one or more of the speakers 118 (e.g., including one or more speakers 118 disposed in a beamforming speaker array 320 or a beamforming speaker array 322) to generate audio output based on the determined location of the portable electronic device 400. For example, in one or more implementations, apparatus 100 may be implemented as a moveable platform (e.g., a vehicle such as an autonomous or semiautonomous vehicle). In one or more implementations, the apparatus 100 may include an enclosure 108, communications circuitry (e.g., RF circuitry 103), a speaker (e.g., any or all of speakers 118, beamforming speaker array 320, and/or beamforming speaker array 322), and a computing component (e.g., processor 190). In one or more implementations, the apparatus 100 may also include one or more sensors (e.g., sensors 113, camera 111, and/or RF circuitry 103).

The computing component may operate the communications circuitry to detect the portable electronic device 400 within the enclosure 108. The computing component may determine the location 500 of the portable electronic device 400 within the enclosure 108 (e.g., using the sensor). The computing component may receive, by the communications circuitry, audio content from the portable electronic device 400. The audio content may correspond to video content being displayed by (e.g., the display 410 of) the portable electronic device 400. The computing component may operate the speaker 118, based on the determined location 500 of the portable electronic device 400 and while the portable electronic device 400 displays the video content, to generate an audio output corresponding to the audio content.

For example, the audio content may include an audio track of a movie, a television show, a video game, or other video content being displayed on the display 410 of the portable electronic device 400. Generating the audio output based on the location 500 of the portable electronic device 400 may allow the apparatus 100 to maintain the perception, by a user of the portable electronic device 400, that at least a portion of the audio output is anchored to the location 500 at which the corresponding video content is being displayed. In one or more implementations, all of the audio content may be output, by the speaker(s) 118 and based on the location 500, to be perceived as originating from the location 500. In one or more other implementations, only some (e.g., a center channel or a dialog channel) may be output, by the speaker(s) 118 and based on the location 500, to be perceived as originating from the location 500, and other portions of the audio content (e.g., a surround channel, a rear height channel, etc.) may be output to be perceived as originating at another location within the enclosure 108.

Because the portable electronic device 400 is portable, the portable electronic device 400 may be moved around within the enclosure 108. In one or more implementations, the computing component may determine (e.g., using one or more sensors of the apparatus 100 and/or based on a communication from the portable electronic device) a change in the location 500 of the portable electronic device 400 within the enclosure 108, and modify the operation of the speaker based on the determined change in the location (e.g., to direct or beam the audio content or a portion thereof to a new location of the portable electronic device).

In one or more implementations, the portable electronic device 400 and the apparatus 100 cooperate to generate coordinated audio outputs corresponding to video content that is being displayed by the display 410 of the portable electronic device 400. For example, the computing component may operate the speaker(s) 118, based on the determined location 500 of the portable electronic device 400, while the portable electronic device 400 displays the video content, and while the portable electronic device 400 generates (e.g., using device speaker(s) 414) an additional audio output corresponding to the audio content.

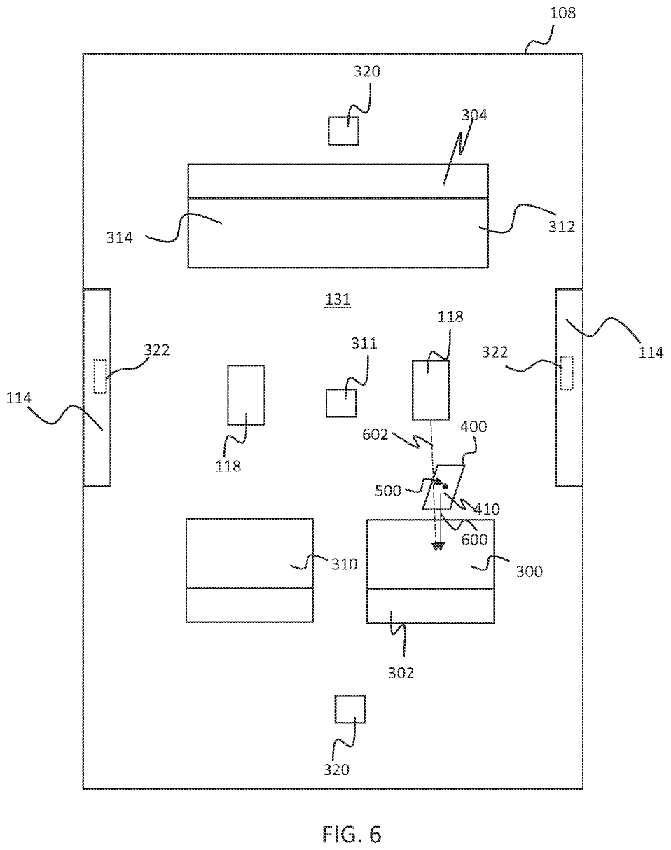

For example, FIG. 6 illustrates an example use case in which the portable electronic device 400, having a display 410, a device speaker 414, communications circuitry, and one or more processors, operates the device speaker 414 to generate an audio output 600, and the apparatus 100 operates a speaker 118 to concurrently generate an audio output 602. For example, the portable electronic device 400 may be a device of a user located in the seat 300. However, because the speaker 118 is located further from the seat 300 than the portable electronic device 400 is from the seat 300, the apparatus 100 and the portable electronic device 400 may cooperate to cause the same content in the audio output 600 and the audio output 602 to arrive at the seat 300 at the same time.

As examples, the portable electronic device 400 may delay the audio content of the audio output 600 relative to the same audio content in the audio output 602, or the apparatus 100 may generate the audio output 602 such that a portion of the audio content in the audio output 602 is output before (e.g., one, two, three, five, or ten milliseconds before) the portable electronic device 400 generates the same audio content in the audio output 600. The delay may be based on the location of the portable electronic device 400 relative to the speaker(s) 118 and/or relative to the seat 300. In this way, the audio output 600 and the audio output 602 can be generated concurrently, but with the audio content therein shifted in time to cause the same content in the audio output 600 and the audio output 602 to arrive at the seat 300 at the same time.

In one or more implementations, the apparatus 100 may control the relative timing of the audio output 602 to the timing of the audio output 600. For example, in one or more implementations, the apparatus 100 (e.g., a computing component of the apparatus, such as processor 190) may operate one or more of the speakers 118, based on the determined location 500 of the portable electronic device 400, in part, by generating the audio output 602 of the speaker 118 such that a portion of the audio content in the audio output 602 is output before the same audio content in the audio output 600 is output by the portable electronic device. For example, the portable electronic device 400 may provide timing information along with the audio content, and the apparatus 100 may advance the audio content in the output of the audio output 602 using the timing information and the location 500, to cause the portion of the audio content in the audio output 602 to arrive at the seat 300 at the same time as the same audio content in the audio output 600, in synchronization with the video content that is being displayed on the display 410.

In various implementations, the video content that is displayed by the portable electronic device 400 may be previously recorded video content (e.g., previously recorded movies, television shows, etc. that have been downloaded to the portable electronic device 400 and/or that are streamed to the portable electronic device 400 from a content provider server), gaming content corresponding to a video game being played by a user of the portable electronic device 400, and/or live-streaming video content received from a remote system by the portable electronic device (as examples).

In one or more other implementations, the portable electronic device 400 may control the relative timing of the audio output 602 relative to the audio output 600. For example, in one or more implementations, the portable electronic device 400 (e.g., one or more processors of the portable electronic device) may determine that the portable electronic device 400 is within the enclosure 108 of the apparatus 100, such as a moveable platform implementation of the apparatus 100. The portable electronic device 400 may operate the display 410 to display video content. The portable electronic device 400 may also operate communications circuitry of the portable electronic device 400 to provide audio content corresponding to the displayed video content to the moveable platform for audio output of the audio content by a speaker 118 of the moveable platform. The portable electronic device 400 may operate the device speaker 414 to generate device audio output corresponding to the audio content, delayed relative to the audio output of the audio content by the speaker 118 of the apparatus 100.

In one or more implementations, the apparatus 100 may determine (e.g., using one or more camera(s) 111, one or more sensor(s) 113, and/or RF circuitry 103) a location of the portable electronic device 400 within the enclosure 108. In various implementations, the apparatus (e.g., processor 190) may operate RF circuitry 103 to exchange UWB communication with the portable electronic device 400 to determine the location of the portable electronic device 400, may use other sensors such depth sensors to determine the location of the portable electronic device 400, and/or may use computer vision processes to identify the portable electronic device 400 and its location using one or more images captured by one or more camera(s) 111 (as examples). In one or more other implementations, the portable electronic device 400 may operate the communications circuitry of the portable electronic device 400 to provide location information indicating a location 500 of the portable electronic device 400 within the enclosure to the apparatus 100 for operation of the speaker 118 of the apparatus 100 based on the location 500 of the portable electronic device 400 within the enclosure 108. In one or more implementations, the portable electronic device 400 may determine (e.g., using a global positioning sensor, an inertial sensor such as an accelerometer, a gyroscope, and/or a magnetometer, and/or the communications circuitry) a change in the location 500 of the portable electronic device 400 within the enclosure 108. The portable electronic device 400 may provide updated location information indicating the change in the location 500 to the apparatus 100 for updated audio output of the audio content by the speaker 118 of the apparatus based on the change in the location.

In one or more implementations, the audio content corresponding to the audio output 600 may be center channel content (e.g., a dialog channel), and the portable electronic device 400 may also provide additional audio content corresponding to another channel corresponding to the displayed video content to the apparatus 100 for audio output of the other channel by at least another speaker 118 of the apparatus 100. As examples, the other channel may include a surround channel, a rear height channel, an ambience channel, or any other suitable audio content corresponding to the video content.

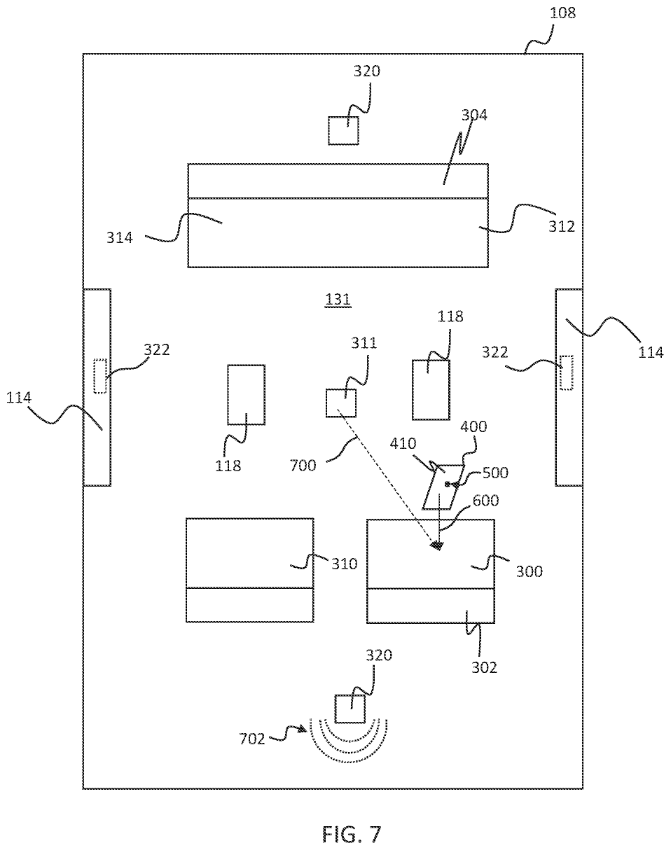

For example, as shown in FIG. 7, in one or more implementations, the apparatus 100 may output center channel content 700 using a center speaker 311 (e.g., an omnidirectional speaker, a directional speaker, or a beamforming array of speakers). In one or more implementations, the apparatus 100 may also, or alternatively output the center channel content 700 using a directional speaker implementation of speaker 118 that is arranged to project audio output toward the location 500, and/or using a beamforming speaker array to beam the center channel content to the location 500. In the example of FIG. 7, the apparatus 100 also operates a beamforming speaker array 320 (e.g., and/or a beamforming speaker array 322) to beam surround channel content 702 toward a rear wall of the enclosure 108. In one or more implementations, the apparatus 100 may also operate a beamforming speaker array 320 and/or a beamforming speaker array 322 to beam a rear height channel toward a ceiling of the enclosure 108, and/or to beam an ambience channel toward a corner of the enclosure 108.

In one or more implementations, a speaker 118 may be implemented as a directional speaker and the apparatus 100 may operate the speaker based on the determined location 500 of the portable electronic device by operating the directional speaker to direct a center channel of the audio content toward the determined location 500 of the portable electronic device 400. In one or more implementations, a speaker 118 may be a first speaker of a beamforming speaker array, and the apparatus may operate the speaker (e.g., and the other speakers of the beamforming speaker array) based on the determined location 500 of the portable electronic device 400 by operating the beamforming speaker array to direct a center channel of the audio content toward the determined location 500 of the portable electronic device 400.

In one or more implementations, a speaker 118 may be a first speaker, the apparatus 100 may include at least a second speaker, and the apparatus may also operate the speaker 118 based on the determined location 500 of the portable electronic device 400 by operating the first speaker to project a first audio output corresponding to a center channel of the audio content toward the location 500 of the portable electronic device 400, operate at least the second speaker to project a second audio output corresponding to another channel of the audio content toward another location within the enclosure 108.

In the examples of FIGS. 6 and 7, the apparatus 100 and/or the portable electronic device 400 control the relative timing of various audio outputs and/or control the location toward which audio output corresponding to one or more audio channels is directed, based on the location 500 of the portable electronic device 400. In one or more implementations, the apparatus 100 may also, or alternatively, operate a speaker 118 based on the determined location 500 of the portable electronic device 400 by operating one or more speakers 118 of the apparatus 100 to generate audio output at a perceived phantom center at the determined location of the portable electronic device. A phantom center may be a location from which audio output, generated by multiple speakers at locations other than the location of the phantom center, is perceived to emanate.

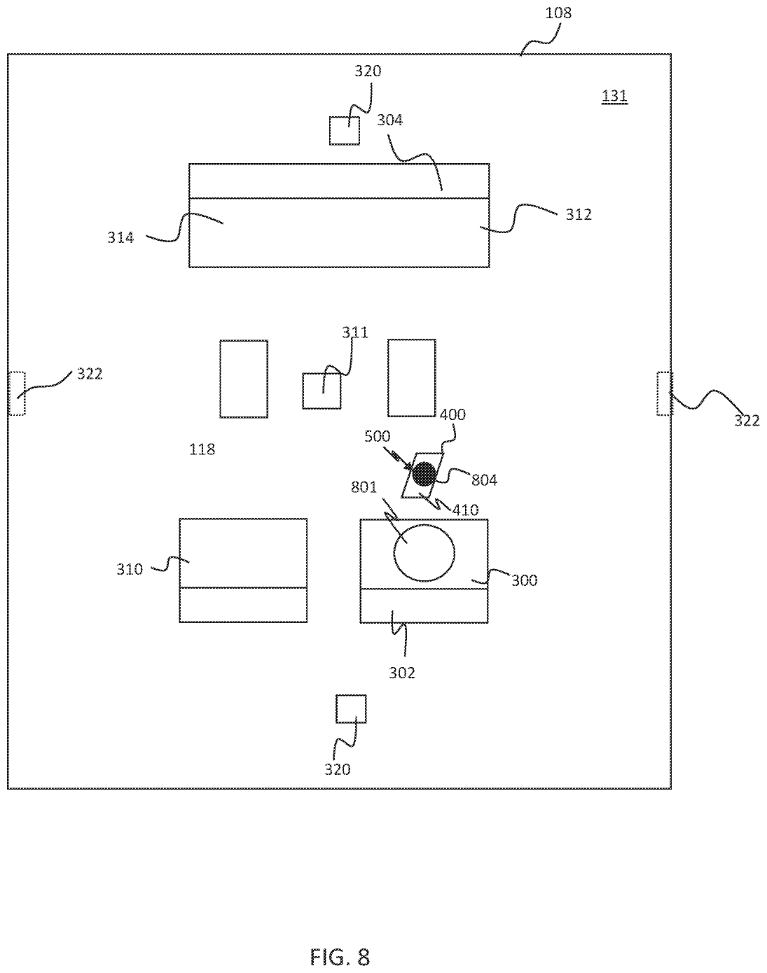

For example, FIG. 8 illustrates that the apparatus 100 can modify the operation of one or more speakers 118 of the apparatus 100 to create a phantom center 804 of the audio output of the speakers 118, at the location 500 of the portable electronic device 400 that is displaying video content. For example, the apparatus 100 may utilize one or more directional speakers and/or one or more beamforming speaker arrays to direct and/or beam audio output within the enclosure 108 to create a psycho-acoustic effect for an occupant 801 within the enclosure 108. This psycho-acoustic effect can cause the occupant 801 to perceive the sound generated within the enclosed environment 131 as originating at the phantom center 804 (e.g., even if no physical speaker of the apparatus 100 is located at the phantom center 804, and/or even if the device speaker(s) 414 of the portable electronic device 400 are not operating).

In the example of FIG. 8, a single occupant 801 is disposed in the seat 300 with a single portable electronic device 400 in the enclosed environment 131, and a single phantom center 804 is generated at the location 500 of the portable electronic device 400. In other example use cases, a single occupant 801 may be determined (e.g., by the processor 190 using one or more cameras 111 and/or one or more sensors 113) to be operating a portable electronic device 400 at the seat 310, the seat 312, or the seat 314 (e.g., or another location within the enclosed environment 131), and the phantom center 804 may be adjusted for the location of the portable electronic device 400 of the occupant 801 in the seat 310, the seat 312, or the seat 314, using similar speaker operations to those described above for the example of the seat 300.

In one or more other example use cases, more than one occupant and/or more than one portable electronic device may be located within the enclosed environment 131. As examples, two, three, or more than three portable electronic devices may be determined to be located at two, three, or more than three respective locations within the enclosed environment 131. In such use cases, the apparatus 100 may receive audio content from one, two, more than two, or all of the portable electronic devices 400 corresponding to respective video content being displayed on those portable electronic devices, and may operate one or more of the speakers 118 of the apparatus to generate audio outputs based on the received audio content and based on the locations of the one, two, more than two, or all of the portable electronic devices 400. For example, the apparatus 100 may operate one or more of the speakers 118 of the apparatus to generate various different audio outputs at various different phantom centers corresponding to the locations of various portable electronic devices 400 within the enclosed environment 131.

In one illustrative example, the apparatus 100 (e.g., the processor 190, using one or more cameras 111 and/or one or more sensors 113) determines that a first occupant having a first portable electronic device displaying first video content is present in the seat 310 and a second occupant having second portable electronic device displaying second video content is present in the seat 312. In this example, the apparatus 100 (e.g., a computing component of the apparatus, such as the processor 190) modifies the output of one or more speakers 118 to generate a first phantom center for the first audio content at the location of the first portable electronic device, and a second phantom center for the second audio content at the location of the second portable electronic device. In this example, two portable electronic devices are disposed at two locations within the enclosure 108. In other example use cases, more than two portable electronic devices may be disposed at more than two locations within the enclosure 108, and the speakers 118 may be operated to generate more than two phantom centers at the more than two locations, and/or otherwise operate the speakers 118 based on the more than two locations.

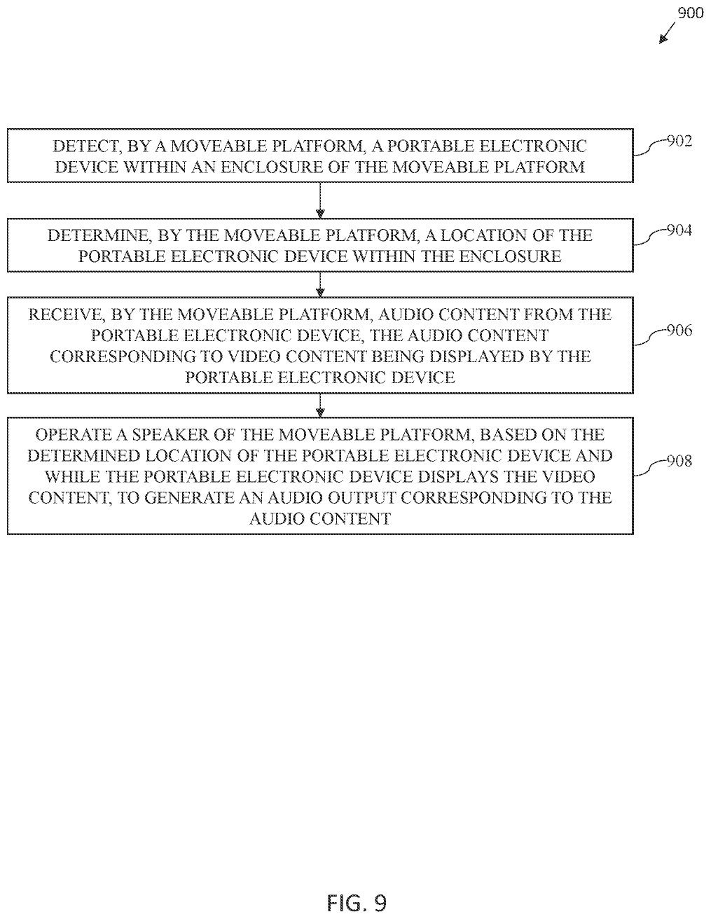

FIG. 9 illustrates a flow diagram of an example process 900 for providing audio integration of a portable electronic device in an enclosed environment, in accordance with implementations of the subject technology. For explanatory purposes, the process 900 is primarily described herein with reference to the apparatus 100 and the portable electronic device 400 of FIGS. 1, 2 and 4. However, the process 900 is not limited to the apparatus 100 and the portable electronic device 400 of FIGS. 1, 2 and 4, and one or more blocks (or operations) of the process 900 may be performed by one or more other components of other suitable devices or systems. Further for explanatory purposes, some of the blocks of the process 900 are described herein as occurring in serial, or linearly. However, multiple blocks of the process 900 may occur in parallel. In addition, the blocks of the process 900 need not be performed in the order shown and/or one or more blocks of the process 900 need not be performed and/or can be replaced by other operations.

As illustrated in FIG. 9, at block 902, moveable platform, such as apparatus 100, may detect a portable electronic device (e.g., portable electronic device 400) within an enclosure (e.g., enclosure 108) of the moveable platform. In one or more implementations, the moveable platform may be a vehicle, such as an autonomous vehicle or a semiautonomous vehicle. For example, the moveable platform may detect the portable electronic device using one or more sensors of the moveable platform (e.g., based on wireless and/or wired communication with communications circuitry of the portable electronic device).

At block 904, the moveable platform may determine a location (e.g., location 500) of the portable electronic device within the enclosure. In one or more implementations, determining the location of the portable electronic device may include determining the location using one or more cameras, such as camera(s) 111, one or more sensors, such as sensors 113 that obtain camera and/or sensor data for mapping the enclosed environment 131 and/or identifying objects (e.g., the portable electronic device 400 and/or one or more occupants), and/or communications circuitry, such as RF circuitry 103, in communication with the portable electronic device.

At block 906, the moveable platform may receive audio content from the portable electronic device, the audio content corresponding to video content being displayed by the portable electronic device. For example, the audio content may be received via a wired or wireless connection between the moveable platform and the portable electronic device.

At block 908, the moveable platform (e.g., processor 190) may operate a speaker (e.g., one or more of the speakers 118 described herein) of the moveable platform, based on the determined location of the portable electronic device and while the portable electronic device displays the video content, to generate an audio output corresponding to the audio content (e.g., and the video content).

In one or more implementations, operating the speaker may include operating the speaker based on the determined location of the portable electronic device, while the portable electronic device displays the video content, and while the portable electronic device generates an additional audio output corresponding to the audio content (e.g., using one or more device speakers 414). In one or more implementations, operating the speaker may include operating the speaker, based on the determined location of the portable electronic device to generate the audio output of the speaker such that a portion of the audio content in the audio output of the speaker is output before the portion of the audio content is output in the additional audio output that is generated by the portable electronic device (e.g., as described herein in connection with FIG. 6).

In one or more implementations, the speaker may be implemented as a directional speaker (e.g., a directional speaker having one or more sound-suppressing acoustic ducts, a dual-directional speaker having acoustic ducts, an isobaric cross-firing speaker, or any other directional speaker), and operating the speaker may include operating the speaker based on the determined location of the portable electronic device by operating the directional speaker to direct a center channel of the audio content toward the determined location of the portable electronic device.

In one or more implementations, the speaker may be a first speaker of a beamforming speaker array (e.g., beamforming speaker array 320 and/or beamforming speaker array 322), and operating the speaker may include operating the speaker based on the determined location of the portable electronic device by operating the beamforming speaker array to direct a center channel of the audio content toward the determined location of the portable electronic device. In one or more implementations, the beamforming speaker array and/or one or more other speakers and/or speaker arrays may also be used to beam one or more other audio channels toward one or more other locations within the enclosure (e.g., as described above in connection with FIG. 7).

In one or more implementations, the speaker may be a first speaker, the moveable platform may include at least a second speaker, and operating the speaker may include operating the speaker based on the determined location of the portable electronic device by operating the first speaker and at least the second speaker (e.g., as a beamforming speaker array) to generate the audio output at a perceived phantom center at the determined location of the portable electronic device (e.g., as described herein in connection with FIG. 8).

In one or more implementations, the moveable platform may also determine a change in the location of the portable electronic device within the enclosure. The moveable platform may modify the operation of the speaker based on the determined change in the location. For example, modifying the operation of the speaker based on the determined change in the location may include operating the speaker to direct at least a portion of the audio output from the speaker to a new location of the portable electronic device, and/or to anchor at least a portion of the audio output from the speaker to the location of the portable electronic device (e.g., including while the portable electronic device is moving within the enclosure 108).

In one or more implementations, operating the speaker based on the determined location of the portable electronic device may include operating the speaker to project a first audio output corresponding to a center channel of the audio content toward the location of the portable electronic device, and the process 900 may also include operating at least a second speaker (e.g., one or more additional speakers 118), while operating the speaker to project the first audio output, to project a second audio output corresponding to another channel of the audio content toward another location within the enclosure (e.g., to project a surround channel toward a rear wall of the enclosure, to project a rear height channel toward a ceiling of the enclosure, and/or to project an ambience channel toward a corner of the enclosure, such as described above in connection with FIG. 8). In one or more implementations, projecting an audio output toward a particular location in an enclosed environment may include suppressing (e.g., passively or actively) the audio output in one or more other locations within the enclosed environment.

In the example of FIG. 9, the movable platform (e.g., the apparatus 100) controls the output of one or more speakers of the moveable platform based on the location of the portable electronic device (e.g., the portable electronic device 400) and in synchronization with video content being displayed by the portable electronic device. As described herein, in one or more implementations, the portable electronic device (e.g., portable electronic device 400) may also, or alternatively, control the output of audio content from the portable electronic device, to spatially and/or temporally synchronize with the audio output of one or more speakers 118 of the moveable platform.

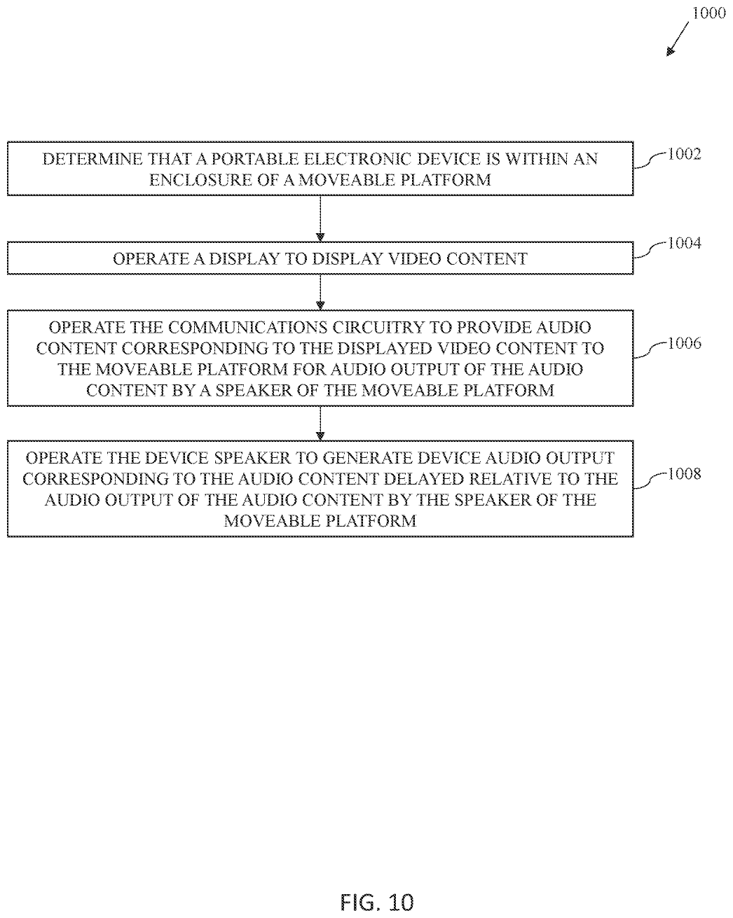

For example, FIG. 10 illustrates a flow diagram of an example process 1000 for operating a portable electronic device for audio integration of the portable electronic device in an enclosed environment, in accordance with implementations of the subject technology. For explanatory purposes, the process 1000 is primarily described herein with reference to the apparatus 100 and the portable electronic device 400 of FIGS. 1, 2 and 4. However, the process 1000 is not limited to the apparatus 100 and the portable electronic device 400 of FIGS. 1, 2 and 4, and one or more blocks (or operations) of the process 1000 may be performed by one or more other components of other suitable devices or systems. Further for explanatory purposes, some of the blocks of the process 1000 are described herein as occurring in serial, or linearly. However, multiple blocks of the process 1000 may occur in parallel. In addition, the blocks of the process 1000 need not be performed in the order shown and/or one or more blocks of the process 1000 need not be performed and/or can be replaced by other operations.

As illustrated in FIG. 10, at block 1002, a portable electronic device (e.g., portable electronic device 400) may determine that the portable electronic device is within an enclosure (e.g., enclosure 108) of a moveable platform (e.g., a moveable platform implementation of the apparatus 100). For example, the portable electronic device may determine that the portable electronic device is within the enclosure by receiving a proximity-based communication (e.g., a wired or wireless communication) from communication circuitry of the moveable platform). In one or more implementations, the moveable platform may be a vehicle, such as an autonomous vehicle or a semiautonomous vehicle.

At block 1004, the portable electronic device may operate a display (e.g., display 410) of the portable electronic device to display video content. In one or more implementations, the video content may include previously recorded video content. In one or more implementations, the video content may include live-streaming video content received from a remote system by the portable electronic device. In one or more implementations, the video content may include gaming content.

At block 1006, the portable electronic device may operate communications circuitry of the portable electronic device to provide audio content corresponding to the displayed video content to the moveable platform for audio output (e.g., audio output 602) of the audio content by a speaker (e.g., one or more of speakers 118) of the moveable platform. In one or more implementations, providing the audio content corresponding to the displayed video content to the moveable platform may include encoding, compressing, and/or transmitting the audio content to communications circuitry of the moveable platform. In one or more implementations, the portable electronic device may also provide timing information with the audio content, for spatial and/or temporal synchronization of the audio output of by the speaker of the moveable platform with the video content displayed by the display of the portable electronic device.

At block 1008, the portable electronic device may operate the device speaker to generate device audio output (e.g., audio output 600) corresponding to the audio content, delayed relative to the audio output of the audio content by the speaker of the moveable platform (e.g., as described above in connection with FIG. 6). For example, the portable electronic device may delay, by a delay time, audio content in the device audio output of the device speaker relative to the same audio content in an audio output from a speaker of the moveable platform. For example, the delay time may be based on a greater distance between the portable electronic device and a user of the portable electronic device, than a distance between the user and the speaker of the apparatus. In various implementations, the distance between the user and the speaker of the apparatus, the distance between the portable electronic device and the user, and/or a distance between the speaker of the apparatus and the portable electronic device may be estimated based on known locations of the speaker of the apparatus and a seat in the apparatus at which the user is seated, and/or may be measured using one or more cameras and/or one or more sensors of the apparatus and/or of the portable electronic device. In one or more implementations, the portable electronic device may operate multiple device speakers to generate the device audio output.

In one or more implementations, the portable electronic device may also operate the communications circuitry of the portable electronic device to provide location information indicating a location (e.g., location 500) of the portable electronic device within the enclosure to the moveable platform, for operation of the speaker of the moveable platform based on the location of the portable electronic device within the enclosure.

In one or more implementations, the portable electronic device may also (e.g., if a user of the portable electronic device moves the portable electronic device relative to their self, and/or if the user moves within the enclosure while carrying the portable electronic device) determine a change in the location of the portable electronic device within the enclosure. The portable electronic device may also provide updated location information indicating the change in the location to the moveable platform, for updated audio output of the audio content by the speaker of the moveable platform based on the change in the location.

In one or more implementations, the audio content may include center channel content, and the portable electronic device may also operate the communications circuitry to provide additional audio content corresponding to another channel corresponding to the displayed video content to the moveable platform for audio output of the other channel by at least another speaker of the moveable platform (e.g., as described above in connection with FIG. 7).

In various examples discussed herein (e.g., such as the example of FIG. 6), one or more speakers 118 of the apparatus 100 are operated based on a location of a single portable electronic device, which may be associated with an occupant (e.g., a smartphone or a tablet carried into and/or otherwise operated within the enclosure 108 by the occupant). In one or more implementations, the apparatus may determine the locations of more than one portable electronic device within the enclosure 108 and associated with the same occupant, and operate the one or more speakers 118 based on the locations of two or more of the portable electronic devices. For example, an occupant may have a smartphone and a tablet, and may transfer video playback from the smartphone to the tablet. In this example use case, an apparatus 100 that was operating one or more speakers 118 based on a location of the smartphone may determine the location of the tablet, and update the operation of one or more speakers 118 based on the location of the tablet. In another example use case, the occupant may play video content on a tablet while wearing a smart watch or a personal speaker. In one or more implementations, the tablet and the smartwatch or personal speaker may both generate audio output, and the apparatus 100 may generate audio output based on the locations and audio output of both the tablet and the smartwatch personal speaker.

Various processes defined herein consider the option of obtaining and utilizing a user's personal information. For example, such personal information may be utilized for audio integration of a portable electronic device in an enclosed environment. However, to the extent such personal information is collected, such information should be obtained with the user's informed consent. As described herein, the user should have knowledge of and control over the use of their personal information.

Personal information will be utilized by appropriate parties only for legitimate and reasonable purposes. Those parties utilizing such information will adhere to privacy policies and practices that are at least in accordance with appropriate laws and regulations. In addition, such policies are to be well-established, user-accessible, and recognized as in compliance with or above governmental/industry standards. Moreover, these parties will not distribute, sell, or otherwise share such information outside of any reasonable and legitimate purposes.

Users may, however, limit the degree to which such parties may access or otherwise obtain personal information. For instance, settings or other preferences may be adjusted such that users can decide whether their personal information can be accessed by various entities. Furthermore, while some features defined herein are described in the context of using personal information, various aspects of these features can be implemented without the need to use such information. As an example, if user preferences, account names, and/or location history are gathered, this information can be obscured or otherwise generalized such that the information does not identify the respective user.

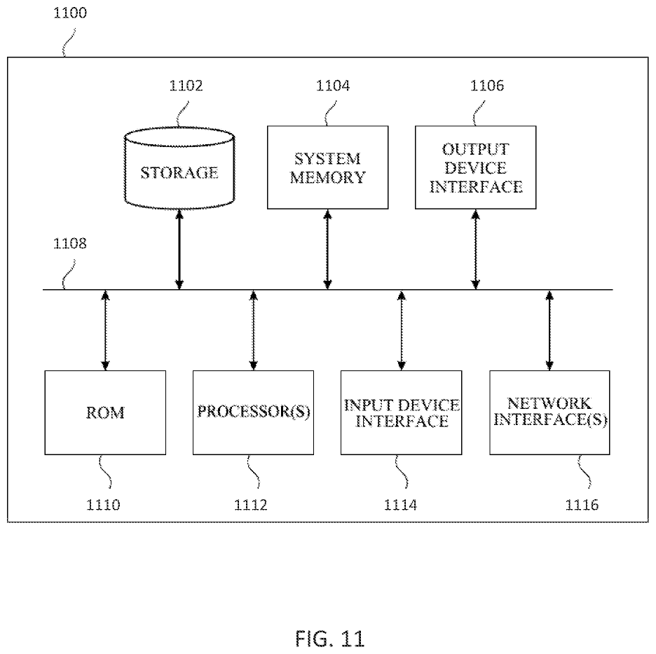

FIG. 11 illustrates an electronic system 1100 with which one or more implementations of the subject technology may be implemented. The electronic system 1100 can be, and/or can be a part of, the portable electronic device 400 shown in FIG. 4. The electronic system 1100 may include various types of computer readable media and interfaces for various other types of computer readable media. The electronic system 1100 includes a bus 1108, one or more processing unit(s) 1112, a system memory 1104 (and/or buffer), a ROM 1110, a permanent storage device 1102, an input device interface 1114, an output device interface 1106, and one or more network interfaces 1116, or subsets and variations thereof.

The bus 1108 collectively represents all system, peripheral, and chipset buses that communicatively connect the numerous internal devices of the electronic system 1100. In one or more implementations, the bus 1108 communicatively connects the one or more processing unit(s) 1112 with the ROM 1110, the system memory 1104, and the permanent storage device 1102. From these various memory units, the one or more processing unit(s) 1112 retrieves instructions to execute and data to process in order to execute the processes of the subject disclosure. The one or more processing unit(s) 1112 can be a single processor or a multi-core processor in different implementations.

The ROM 1110 stores static data and instructions that are needed by the one or more processing unit(s) 1112 and other modules of the electronic system 1100. The permanent storage device 1102, on the other hand, may be a read-and-write memory device. The permanent storage device 1102 may be a non-volatile memory unit that stores instructions and data even when the electronic system 1100 is off. In one or more implementations, a mass-storage device (such as a magnetic or optical disk and its corresponding disk drive) may be used as the permanent storage device 1102.

In one or more implementations, a removable storage device (such as a floppy disk, flash drive, and its corresponding disk drive) may be used as the permanent storage device 1102. Like the permanent storage device 1102, the system memory 1104 may be a read-and-write memory device. However, unlike the permanent storage device 1102, the system memory 1104 may be a volatile read-and-write memory, such as random access memory. The system memory 1104 may store any of the instructions and data that one or more processing unit(s) 1112 may need at runtime. In one or more implementations, the processes of the subject disclosure are stored in the system memory 1104, the permanent storage device 1102, and/or the ROM 1110. From these various memory units, the one or more processing unit(s) 1112 retrieves instructions to execute and data to process in order to execute the processes of one or more implementations.

The bus 1108 also connects to the input and output device interfaces 1114 and 1106. The input device interface 1114 enables a user to communicate information and select commands to the electronic system 1100. Input devices that may be used with the input device interface 1114 may include, for example, alphanumeric keyboards and pointing devices (also called “cursor control devices”). The output device interface 1106 may enable, for example, the display of images generated by electronic system 1100. Output devices that may be used with the output device interface 1106 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 11, the bus 1108 also couples the electronic system 1100 to one or more networks and/or to one or more network nodes, through the one or more network interface(s) 1116. In this manner, the electronic system 1100 can be a part of a network of computers (such as a LAN, a wide area network (“WAN”), or an Intranet, or a network of networks, such as the Internet. Any or all components of the electronic system 1100 can be used in conjunction with the subject disclosure.

In accordance with aspects of the subject disclosure, a moveable platform is provided, including an enclosure; communications circuitry; a speaker; and a computing component configured to: determine a location of the portable electronic device within the enclosure; receive, by the communications circuitry, audio content from the portable electronic device, the audio content corresponding to video content being displayed by the portable electronic device; and operate the speaker, based on the determined location of the portable electronic device and while the portable electronic device displays the video content, to generate an audio output corresponding to the audio content.

In accordance with aspects of the subject disclosure, a portable electronic device is provided that includes a display; a device speaker; communications circuitry; and one or more processors configured to: determine that the portable electronic device is within an enclosure of a moveable platform; operate the display to display video content; and operate the communications circuitry to provide audio content corresponding to the displayed video content to the moveable platform for audio output of the audio content by a speaker of the moveable platform; and operate the device speaker to generate device audio output corresponding to the audio content, delayed relative to the audio output of the audio content by the speaker of the moveable platform.

In accordance with aspects of the subject disclosure, a method is provided, the method including detecting, by a moveable platform, a portable electronic device within an enclosure of the moveable platform; determining, by the moveable platform, a location of the portable electronic device within the enclosure; receiving, by the moveable platform, audio content from the portable electronic device, the audio content corresponding to video content being displayed by the portable electronic device; and operating a speaker of the moveable platform, based on the determined location of the portable electronic device and while the portable electronic device displays the video content, to generate an audio output corresponding to the audio content.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neutral gender (e.g., her and its) and vice versa. Headings and subheadings, if any, are used for convenience only and do not limit the subject disclosure.

What is claimed is:

1. A moveable platform, comprising:
an enclosure;
communications circuitry;
a speaker; and
a computing component configured to:
determine a location of a portable electronic device within the enclosure;
receive, by the communications circuitry, audio content from the portable electronic device, the audio content corresponding to video content being displayed by the portable electronic device; and
operate the speaker, based on the determined location of the portable electronic device and while the portable electronic device displays the video content, to generate an audio output corresponding to the audio content.

2. The moveable platform of claim 1, wherein the computing component is configured to operate the speaker, based on the determined location of the portable electronic device, while the portable electronic device displays the video content, and while the portable electronic device generates an additional audio output corresponding to the audio content.

3. The moveable platform of claim 2, wherein the computing component is configured to operate the speaker, based on the determined location of the portable electronic device to generate the audio output of the speaker such that a portion of the audio content in the audio output of the speaker is output before the portion of the audio content is output in the additional audio output that is generated by the portable electronic device.

4. The moveable platform of claim 1, wherein the speaker comprises a directional speaker, and wherein the computing component is configured to operate the speaker based on the determined location of the portable electronic device by operating the directional speaker to direct a center channel of the audio content toward the determined location of the portable electronic device.

5. The moveable platform of claim 1, wherein the speaker comprises a first speaker of a beamforming speaker array, and wherein the computing component is configured to operate the speaker based on the determined location of the portable electronic device by operating the beamforming speaker array to direct a center channel of the audio content toward the determined location of the portable electronic device.

6. The moveable platform of claim 1, wherein the speaker comprises a first speaker, wherein the moveable platform comprises at least a second speaker, and wherein the computing component is configured to operate the speaker based on the determined location of the portable electronic device by operating the first speaker and at least the second speaker to generate the audio output at a perceived phantom center at the determined location of the portable electronic device.

7. The moveable platform of claim 1, wherein the computing component is further configured to:
determine a change in the location of the portable electronic device within the enclosure; and
modify the operation of the speaker based on the determined change in the location.

8. The moveable platform of claim 1, wherein the speaker comprises a first speaker, wherein the moveable platform comprises at least a second speaker, and wherein the computing component is configured to:
operate the speaker based on the determined location of the portable electronic device by operating the first speaker to project a first audio output corresponding to a center channel of the audio content toward the location of the portable electronic device; and
operate at least the second speaker to project a second audio output corresponding to an other channel of the audio content toward an other location within the enclosure.

9. The moveable platform of claim 1, wherein the moveable platform comprises an autonomous vehicle.

10. The moveable platform of claim 9, wherein the portable electronic device comprises at least one of a smartphone, a smart watch, a tablet device, or a laptop computer.

11. A portable electronic device, comprising:
a display;
a device speaker;
communications circuitry; and
one or more processors configured to:
determine that the portable electronic device is within an enclosure of a moveable platform;
operate the display to display video content;
operate the communications circuitry to provide audio content corresponding to the displayed video content to the moveable platform for audio output of the audio content by a speaker of the moveable platform; and
operate the device speaker to generate device audio output corresponding to the audio content, delayed relative to the audio output of the audio content by the speaker of the moveable platform.

12. The portable electronic device of claim 11, wherein the one or more processors are further configured to operate the communications circuitry to provide location information indicating a location of the portable electronic device within the enclosure to the moveable platform, for operation of the speaker of the moveable platform based on the location of the portable electronic device within the enclosure.

13. The portable electronic device of claim 12, wherein the one or more processors are further configured to:
determine a change in the location of the portable electronic device within the enclosure; and
provide updated location information indicating the change in the location to the moveable platform for updated audio output of the audio content by the speaker of the moveable platform based on the change in the location.

14. The portable electronic device of claim 11, wherein the audio content comprises center channel content, and wherein the one or more processors are further configured to operate the communications circuitry to provide additional audio content corresponding to an other channel corresponding to the displayed video content to the moveable platform for audio output of the other channel by at least an other speaker of the moveable platform.

15. The portable electronic device of claim 11, wherein the video content comprises previously recorded video content.

16. The portable electronic device of claim 11, wherein the video content comprises live-streaming video content received from a remote system by the portable electronic device.

17. The portable electronic device of claim 11, wherein the moveable platform comprises an autonomous vehicle.

18. A method, comprising:
detecting, by a moveable platform, a portable electronic device within an enclosure of the moveable platform;
determining, by the moveable platform, a location of the portable electronic device within the enclosure;
receiving, by the moveable platform, audio content from the portable electronic device, the audio content corresponding to video content being displayed by the portable electronic device; and
operating a speaker of the moveable platform, based on the determined location of the portable electronic device and while the portable electronic device displays the video content, to generate an audio output corresponding to the audio content.

19. The method of claim 18, wherein operating the speaker comprises operating the speaker based on the determined location of the portable electronic device, while the portable electronic device displays the video content, and while the portable electronic device generates an additional audio output corresponding to the audio content.

20. The method of claim 18, further comprising:
determining, by the moveable platform, a change in the location of the portable electronic device within the enclosure; and
modifying the operation of the speaker based on the determined change in the location.

21. The method of claim 18, wherein operating the speaker based on the determined location of the portable electronic device comprises operating the speaker to project a first audio output corresponding to a center channel of the audio content toward the location of the portable electronic device, the method further comprising operating at least a second speaker, while operating the speaker to project the first audio output, to project a second audio output corresponding to an other channel of the audio content toward an other location within the enclosure.
